(19) United States
(12) Patent Application Publication
(10) Pub. No.: US 2004/0010643 A1
(43) Pub. Date: Jan. 15, 2004

(54) Method for providing multiple configurations in a computer system with multiple components

(76) Inventor: William John Thomas III, Carmichael, CA (US)

Correspondence Address: HEWLETT-PACKARD COMPANY, Intellectual Property Administration, P.O. Box 272400, Fort Collins, CO, 80527-2400, US

(21) Appl. No.: 10/192,184

(22) Filed: Jul. 9, 2002

(51) Int. Cl. G06F 13/00

(52) U.S. Cl. 710/104

(57) ABSTRACT

A method for providing multiple component configurations in a computer system comprising a plurality of components. It is determined whether the computer system is in a first configuration, wherein the first configuration indicates that the plurality of components comprises at least one upgradable component. Provided the computer system is in a first configuration, it is determined whether upgrading the computer system to a second configuration is permitted. The second configuration indicates a configuration wherein access is provided to the upgradable component. Provided upgrading to the second configuration is permitted, configuration of the upgradable component is allowed, wherein the configuration is performed by a system configuration command and without requiring manual insertion of the upgradable component into the computer system at the time of the upgrading.

### FIELD OF INVENTION

Various embodiments of the present invention relate to the field of computer hardware configurations.

### BACKGROUND OF THE INVENTION

Computer resource requirements vary from user to user. In some circumstances, computer resource requirements for a user may vary from month to month. For example, consider a small business. When the business first starts out, it may have modest computing requirements. However, as the business gets busier, it may require more computing resources. Currently, products are available that allow for businesses to easily change their computing resources without requiring substantial modification to the business's current computer resources (e.g., restructuring the computer network).

One way for a business to maintain its computing resources is to store a number of blades having computer components within a chassis. A typical chassis can hold a large number of blades. A typical blade has a number of computing components, such as computer processing units (CPUs), memory units, and input/output ports. As explained above, businesses have varying needs for computing resources. As such, it is necessary to offer businesses a variety of computing resource options.

For example, some businesses may require a blade having one CPU, while other businesses may require a blade having two CPUs. Unfortunately, it is not desirable for a manufacturer to support two kinds of processor blades, one having one CPU and one having two CPUs. Supporting two different blades requires additional manufacturing costs and requires supporting repair processes for each blade. Currently, supporting two different blades as described above is not cost effective considering market conditions.

Therefore, it is desirable to have a two-processor blade that can run either one CPU or two CPUs. Currently, two-processor blades are available that can provide the functionality of either one or two CPUs. When a blade is purchased, the customer identifies whether they require one CPU or two CPUs. The firmware of the two-processor blade comprises code identifying the configuration of the blade (e.g., whether one CPU or two CPUs are accessible).

Currently, if a user purchases a two-processor blade having only once accessible CPU, the blade comprises only one CPU with the capability to insert a second CPU in the event an upgrade is desired. If the user of a two-processor blade having one accessible CPU desires an upgrade to full capacity (e.g., two accessible CPUs), the user must purchase a license from the manufacturer. Upon purchase of the license, a user then inputs a license key into the blade. Provided the license key is accepted, the firmware of the blade is upgraded to permit the installation of a second CPU.

However, there are many problems associated with the installation of a second CPU. Currently, a second CPU must be shipped from the manufacturer to the user, subjecting the CPU to potential physical trauma, potentially affecting the performance of the CPU. Furthermore, the new CPU must be manually inserted into the proper blade. This typically requires an on-site technician to perform the installation, which can be a substantial cost to the user. Where a small business desires an upgrade, the cost of a technician to perform the installation may be prohibitive, forcing a user to perform the installation. As with any computer component installation, an installer without experience may incorrectly perform the installation, resulting in further damage and cost to the business.

### SUMMARY OF THE INVENTION

A method for providing multiple component configurations in a computer system comprising a plurality of components. It is determined whether the computer system is in a first configuration, wherein the first configuration indicates that the plurality of components comprises at least one upgradable component. Provided the computer system is in a first configuration, it is determined whether upgrading the computer system to a second configuration is permitted. The second configuration indicates a configuration wherein access is provided to the upgradable component. Provided upgrading to the second configuration is permitted, configuration of the upgradable component is allowed, wherein the configuration is performed by a system configuration command and without requiring manual insertion of the upgradable component into the computer system at the time of the upgrading.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1A is a block diagram of a computer system comprising an upgradable processor in a first configuration in accordance with one embodiment of the present invention.

FIG. 1B is a block diagram of a computer system comprising an upgradable processor in a second configuration in accordance with one embodiment of the present invention.

FIG. 2A is a block diagram of a computer system comprising a plurality of upgradable components in a first configuration in accordance with one embodiment of the present invention.

FIG. 2B is a block diagram of a computer system comprising a plurality of upgradable components in a second configuration in accordance with one embodiment of the present invention.

FIG. 3 is a flow chart illustrating steps in a process for providing multiple component configurations in a computer system in accordance with one embodiment of the present invention.

FIG. 4 is a flow chart illustrating steps in a process for determining whether upgrading a computer system to a second configuration is permitted in accordance with one embodiment of the present invention.

### BEST MODE(S) FOR CARRYING OUT THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and the scope of the invention as defined by the appended claims. Furthermore, in the following detailed description of the present invention, numerous specific details are set forth in order to provide a thorough understanding of the present invention. However, it will be apparent to one skilled in the art that the present invention may be practiced without these specific details. In other instances, well-known methods, procedures, components, structures and devices have not been described in detail so as to avoid unnecessarily obscuring aspects of the present invention.

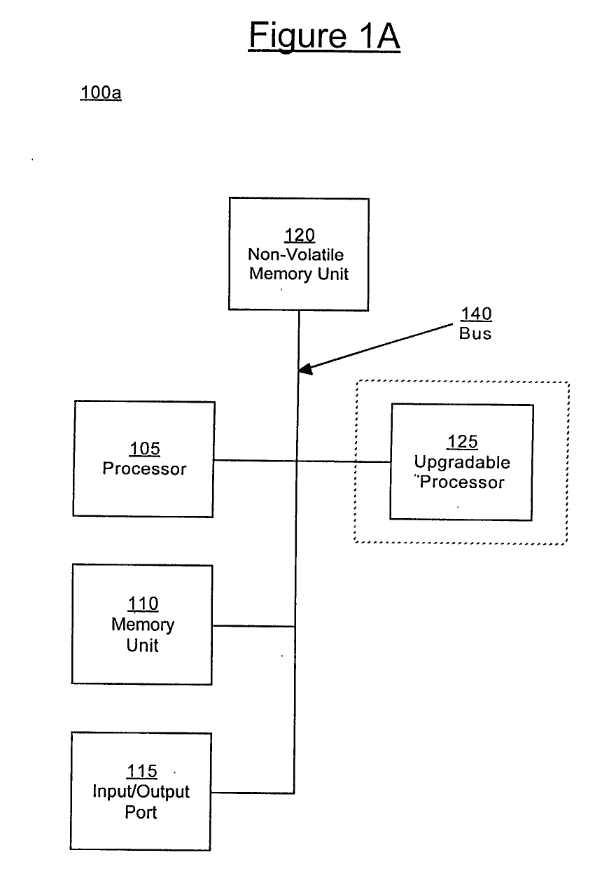

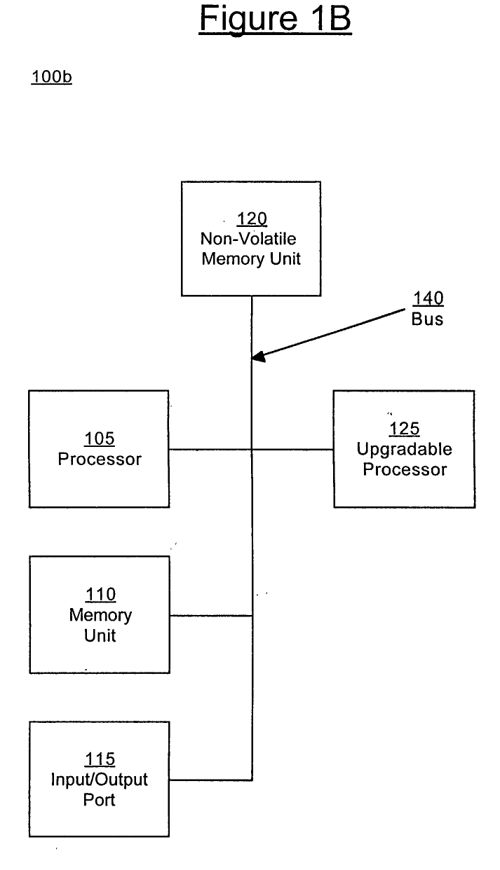

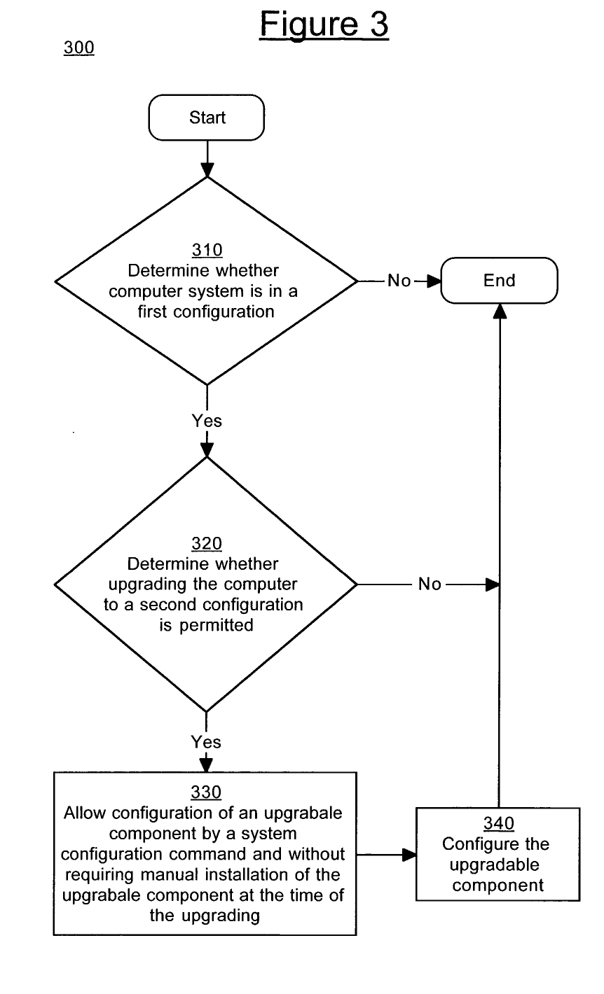

FIG. 1A is a block diagram of a computer system 100a in a first configuration in accordance with one embodiment of the present invention. Computer system 100a shows the components of a computer system in accordance with one embodiment of the present invention that provides the execution platform for implementing certain software-based functionality of the present invention. In one embodiment, certain processes and steps of the present invention are realized as a series of instructions (e.g., software program) that reside within computer readable memory units of a computer system and are executed by the processor(s) of system 100a. When executed, the instructions cause the computer system 100a to implement a process for providing multiple component configurations in computer system 100a (process 300 of FIG. 3) in accordance with one embodiment of the present invention.

In one embodiment, computer system 100a comprises an address/data bus 140 for communicating information, processor 105 coupled with bus 140 for processing information and instructions, memory unit 110 coupled with bus 140, and upgradable processor 125 coupled with bus 140. In one embodiment, memory unit 110 comprises volatile memory (e.g., random access memory, static RAM, dynamic RAM) and non-volatile memory (e.g., read only memory, programmable ROM, flash memory, EPROM, EEPROM).

In one embodiment, computer system 100a comprises optional nonvolatile memory unit 120 (e.g., read only memory, programmable ROM, flash memory, EPROM, EEPROM) coupled with bus 140. Non-volatile memory unit 120 comprises a series of instructions (e.g., software program) for implementing a process for providing multiple component configurations in computer system 100a (process 300 of FIG. 3). In one embodiment, computer system 110a comprises input/output port 115. It should be appreciated that computer system 100a may comprise any number of components used in computer systems, and that computer system 100a is not limited to the present embodiment.

The dotted line of FIG. 1A indicates that upgradable processor 125 is in a downgrade configuration (e.g., a first configuration). A downgrade configuration indicates that upgradable processor 125 is disabled with respect to the typical computer functionality of computer system 100a. It should be appreciated that processor 125 may be accessed by computer system 100a, for events such as diagnostic tests or to act as a backup processor to processor 105. However, in a downgrade configuration, upgradable processor 125 is limited in its accessibility.

FIG. 1B is a block diagram of a computer system 100b in a second configuration in accordance with one embodiment of the present invention. It should be appreciated that computer system 100b comprises the same componentry as computer system 100a of FIG. 1A. However, computer system 100b is in an upgrade configuration (e.g., a second configuration) as indicated by the lack of a dotted line around upgradable processor 125.

In one embodiment, upon receipt and verification of a license key, computer system 100b can access upgradable processor 125. It should be appreciated that upgradable processor 125 is configurable in an upgrade configuration, wherein the configuration is performed by a system configuration command and without requiring manual insertion of upgradable processor 125 at time of upgrade. In an upgrade configuration, upgradable processor 125 is fully configurable and functions as a second processor, with no limitations with respect to its accessibility.

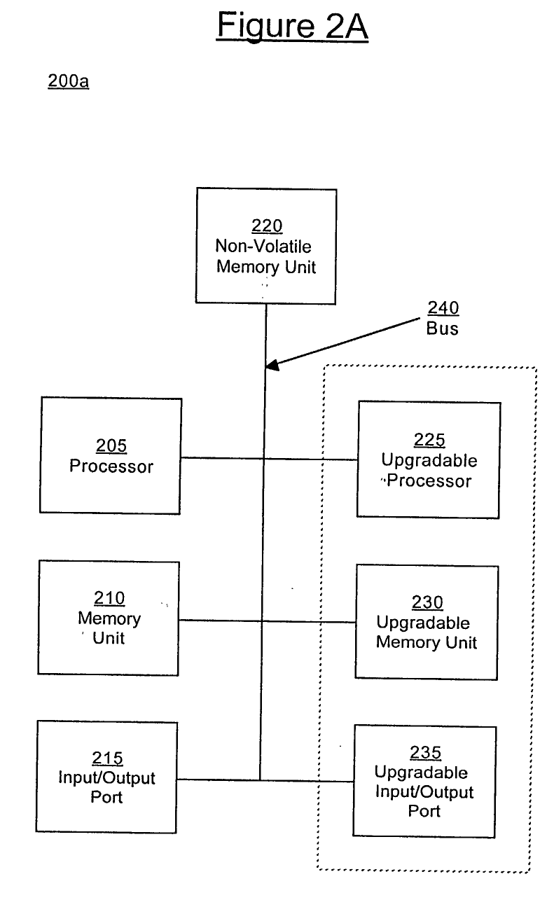

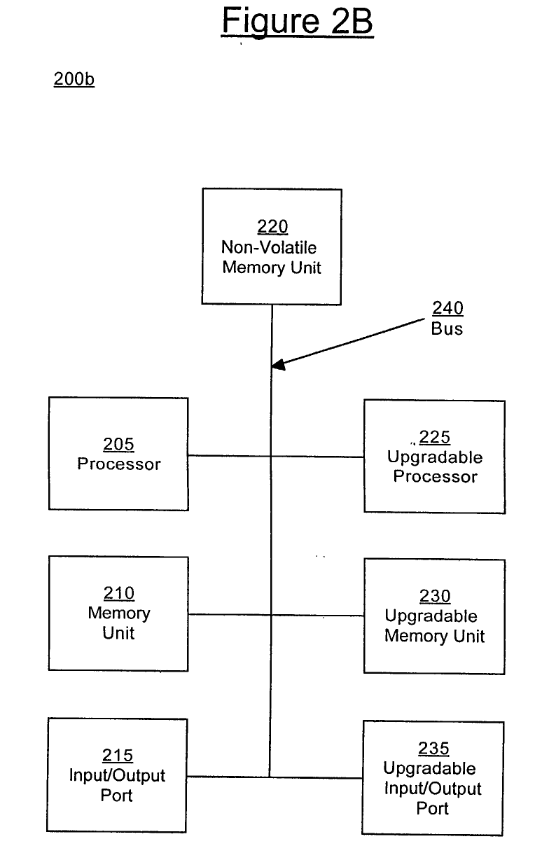

FIG. 2A is a block diagram of a computer system 200a in a first configuration in accordance with one embodiment of the present invention. Computer system 200a shows the components of a computer system in accordance with one embodiment of the present invention that provides the execution platform for implementing certain software-based functionality of the present invention. In one embodiment, certain processes and steps of the present invention are realized as a series of instructions (e.g., software program) that reside within computer readable memory units of a computer system and are executed by the processor(s) of system 200a. When executed, the instructions cause the computer system 200a to implement a process for providing multiple component configurations in computer system 200a (process 300 of FIG. 3) in accordance with one embodiment of the present invention.

Similar to computer system 100a of FIG. 1A, in one embodiment, computer system 200a comprises an address/data bus 240 for communicating information, processor 205 coupled with bus 240 for processing information and instructions, memory unit 210 coupled with bus 240, input/output port 215 coupled with bus 240 and a plurality of upgradable components coupled with bus 240 (e.g., upgradable processor 225, upgradable memory unit 230, and upgradable input/output port 235). In one embodiment, memory unit 210 comprises volatile memory (e.g., random access memory, static RAM, dynamic RAM) and non-volatile memory (e.g., read only memory, programmable ROM, flash memory, EPROM, EEPROM). It should be appreciated that computer system 200a may comprise any number of components used in computer systems, and that computer system 200a is not limited to the present embodiment.

In one embodiment, computer system 200a comprises optional nonvolatile memory unit 220 (e.g., read only memory, programmable ROM, flash memory, EPROM, EEPROM) coupled with bus 240. Non-volatile memory unit 220 comprises a series of instructions (e.g., software program) for implementing a process for providing multiple component configurations in computer system 100a (process 300 of FIG. 3).

The dotted line of FIG. 2A indicates that computer system 200a is in a downgrade configuration, as described above. In the present embodiment, upgradable processor 225, upgradable memory unit 230, and upgradable input/output port 235 are disabled. It should be appreciated that the upgradable components may be accessed by computer system 200a for special events (e.g., diagnostic tests or to act as backups to active componentry.

FIG. 2B is a block diagram of a computer system 200b in a second configuration in accordance with one embodiment of the present invention. It should be appreciated that computer system 200b comprises the same componentry as computer system 200a of FIG. 2A. However, computer system 200b is in an upgrade configuration (e.g., a second configuration) as indicated by the lack of a dotted line around upgradable processor 225, upgradable memory unit 230 and upgradable input/output port 235.

In one embodiment, upon receiving a license key, computer system 200b can access the upgradable componentry. It should be appreciated that the upgradable componentry is configurable in an upgrade configuration, wherein the configuration is performed by a system configuration command and without requiring manual insertion of the upgradable componentry at time of upgrade. For example, in an upgrade configuration, upgradable processor 225 is fully configurable and functions as a second processor, with no limitations with respect to its accessibility.

FIG. 3 is a flow chart illustrating steps in a process 300 for providing multiple component configurations in a computer system in accordance with one embodiment of the present invention. In one embodiment, process 300 is carried out by processors and electrical components under the control of computer readable and computer executable instructions. In one embodiment, process 300 is carried out by computer system 100a of FIG. 1A. In another embodiment, process 300 is carried out by computer system 200a of FIG. 2A. Although specific steps are disclosed in process 300, such steps are exemplary. That is, the embodiments of the present invention are well suited to performing various other steps or variations of the steps recited in FIG. 3.

At step 310 of process 300, it is determined whether a computer system comprising a plurality of components is in a first configuration (e.g., computer system 100a of FIG. 1A or computer system 200a of FIG. 2A), wherein the first configuration indicates that the plurality of components comprises at least one upgradable component. In one embodiment, the first configuration is a downgrade configuration wherein access is provided to a portion of the plurality of components. The current configuration of the computer system is stored in a memory unit of the computer system (e.g., non-volatile memory unit 125 of FIG. 1A). In one embodiment, a computer system in a first configuration (e.g., a downgrade configuration) is indicated as “upgrade false” and a computer system in a second configuration (e.g., an upgrade configuration) is indicated as “upgrade true.” Provided the computer system is not in a first configuration (e.g., is in a second configuration), process 300 ends.

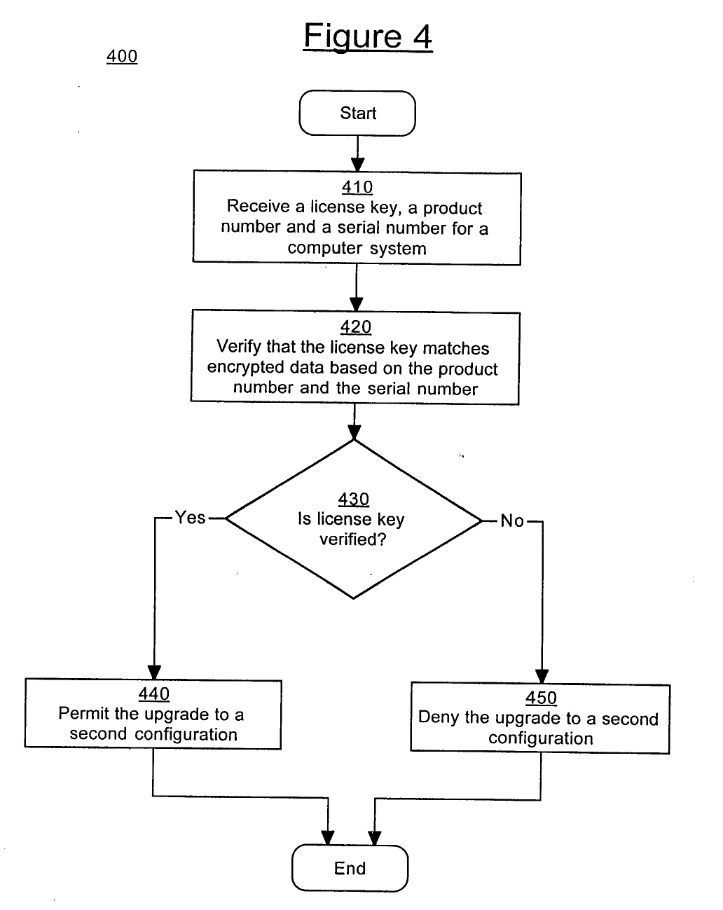

Provided the computer system is in a first configuration, as shown at step 320, it is determined whether upgrading the computer system to a second configuration is permitted, wherein the second configuration indicates a configuration wherein access is provided to the upgradable component. FIG. 4 is a flow chart illustrating steps in a process 400 for determining whether upgrading a computer system to a second configuration is permitted in accordance with one embodiment of the present invention.

At step 410, a license key, a product number and a serial number for the computer system are received. In one embodiment, the license key is obtained by contacting the manufacturer of the computer system and purchasing the license key. The product number and serial number are stored within the computer system (e.g., within non-volatile memory unit 120 of FIG. 1A), and are retrieved internally.

At step 420, a verification that the license key matches encrypted data based on the product number and the serial number is performed. In one embodiment, the encrypted data is based on an encryption algorithm generated by the manufacturer. It should be appreciated that the license key is created by the manufacturer by using an encryption algorithm that receives the product number and the serial number as inputs and provides the license key as an output. The verification determines that the license key as entered matches the license key as created by the encryption algorithm. At step 430, it is determined whether the license key is verified.

Provided the license key is verified, as shown at step 440, upgrading the computer system to the second configuration is permitted, and process 300 of FIG. 3 proceeds to step 330. In one embodiment, the configuration of the computer system is stored as “upgrade true,” indicating that upgrading to a second configuration is permitted.

Alternatively, provided the license key is not verified, as shown at step 450, upgrading the computer system to the second configuration is denied, and process 300 of FIG. 3 ends. In one embodiment, the configuration of the computer system is stored as “upgrade false,” indicating that upgrading to a second configuration is not permitted.

With reference to FIG. 3, provided upgrading to the second configuration is permitted, as shown at step 330, configuration of the upgradable component is allowed. The configuration is performed by a system configuration command and without requiring manual insertion of the upgradable component into the computer system at time of upgrading.

In one embodiment, the system configuration command is operable to deconfigure and configure hardware components of the computer system. The system configuration command used in multiple component environments to support providing additional componentry, to support removing and replacing componentry, and to support diagnostic testing of hardware. In one embodiment of the present invention, the system configuration command comprises a check for automatically upgrading the computer system to a second configuration if the configuration is stored as “upgrade true.” At step 340, the upgradable component is configured.

Embodiments of the present invention provide a method for providing multiple configurations in a computer system with multiple components that does not require manual insertion of upgradable components. Furthermore, embodiments of the present invention do not require manual adjustment of system tables maintained or created by the firmware. Embodiments of the present invention also do not require a network connection to perform a system upgrade.

Embodiments of the present invention, a method for providing multiple configurations in a computer system with multiple components, are thus described. While the present invention has been described in particular embodiments, it should be appreciated that the present invention should not be construed as limited by such embodiments, but rather construed according to the below claims.

What is claimed is:

1. A method for providing multiple component configurations in a computer system, said method comprising:
a) determining whether said computer system is in a first configuration, said computer system comprising a plurality of components, said first configuration indicating said plurality of components comprises at least one upgradable component;
b) provided said computer system is in a first configuration, determining whether upgrading said computer system to a second configuration is permitted, said second configuration indicating a configuration wherein access is provided to said upgradable component; and
c) provided said upgrading to said second configuration is permitted, allowing configuration of said upgradable component, wherein said configuration is performed by a system configuration command and without requiring manual insertion of said upgradable component into said computer system at time of said upgrading.

2. The method as recited in claim 1 wherein said upgradable component is a processor.

3. The method as recited in claim 1 wherein said upgradable component is a memory unit.

4. The method as recited in claim 1 wherein said upgradable component is an input/output port.

5. The method as recited in claim 1 wherein said first configuration is a downgrade configuration wherein access is provided to a portion of said plurality of components.

6. The method as recited in claim 1 wherein said second configuration is an upgrade configuration wherein access is provided to each of said plurality of components.

7. The method as recited in claim 1 wherein said b) comprises:
receiving a license key, a product number and a serial number for said computer system;
verifying said license key matches encrypted data based on said product number and said serial number; and
provided said license key is verified, permitting said upgrading to said second configuration.

8. The method as recited in claim 1 further comprising configuring said upgradable component.

9. A computer-readable medium having computer-readable program code embodied therein for causing a computer system to perform a method for providing multiple component configurations in a computer system without requiring manual insertion of an upgradable component at time of upgrade, said method comprising:
provided said computer system is in a first configuration, determining whether upgrading said computer system to a second configuration is permitted, said computer system comprising a plurality of components, said first configuration indicating said plurality of components comprises at least one upgradable component said second configuration indicating a configuration wherein access is provided to said upgradable component;
provided said upgrading to said second configuration is permitted, allowing configuration of said upgradable component, wherein said configuration is performed by a system configuration command and without requiring manual insertion of said upgradable component at time of said upgrading.

10. The computer-readable medium as recited in claim 9 wherein said upgradable component is a processor.

11. The computer-readable medium as recited in claim 9 wherein said upgradable component is a memory unit.

12. The computer-readable medium as recited in claim 9 wherein said upgradable component is an input/output port.

13. The computer-readable medium as recited in claim 9 wherein said first configuration is a downgrade configuration wherein access is provided to a portion of said plurality of components.

14. The computer-readable medium as recited in claim 9 wherein said second configuration is an upgrade configuration wherein access is provided to each of said plurality of components.

15. The computer-readable medium as recited in claim 9 wherein said determining whether said upgrading said computer system to said second configuration is permitted comprises:
receiving a license key, a product number and a serial number for said computer system;
verifying said license key matches encrypted data based on said product number and said serial number; and
provided said license key is verified, permitting said upgrading to said second configuration.

16. The computer-readable medium as recited in claim 9 further comprising configuring said upgradable component.

17. A computer system comprising:
a bus;
a computer-readable memory coupled to said bus; and
a processor coupled to said bus, said processor for performing a method for providing multiple component configurations in a computer system; and
an upgradable component, wherein said upgradable component is configurable upon verification of a license key, wherein said configuration is performed by a system configuration command and without requiring manual insertion of said upgradable component at time of upgrade.

18. The computer system as recited in claim 17 wherein said upgradable component is a second processor.

19. The computer system as recited in claim 17 wherein said upgradable component is a second computer-readable memory.

20. The computer system as recited in claim 17 further comprising an input/output port.

21. The computer system as recited in claim 20 wherein said upgradable component is a second input/output port.
